(19) United States
(12) Patent Application Publication
(10) Pub. No.: US 2025/0222292 A1
(43) Pub. Date: Jul. 10, 2025

(54) LIQUID FIRE SUPPRESSION SYSTEM FOR A VEHICLE

(71) Applicant: Tyco Fire Products LP, Cranston, RI (US)

(72) Inventors: Chad L. Ryczek, Oconto Falls, WI (US); Alden A. Spencer, Marinette, WI (US)

(73) Assignee: Tyco Fire Products LP, Cranston, RI (US)

(21) Appl. No.: 18/853,371

(22) PCT Filed: Apr. 14, 2023
(86) PCT No.: PCT/IB2023/053810

§ 371 Date: Oct. 1, 2024

Related U.S. Application Data
(60) Provisional application No. 63/331,654, filed on Apr. 15, 2022.

(51) Int. Cl. A62C 3/07; A62C 35/02; A62C 35/13; A62C 37/40

(52) U.S. Cl. CPC A62C 3/07; A62C 35/023; A62C 35/13; A62C 37/40

(57) ABSTRACT

A fire suppression system for a vehicle includes a fire detection device, a tank, a nozzle, and an activator. The fire detection device is configured to detect a fire in a hazard area. The activator is configured to selectively release during a single-agent phase the liquid fire suppressant contained in the tank such that at least a portion of the liquid fire suppressant passes through the outlet of the nozzle in response to the fire detection device detecting the fire.

### CROSS-REFERENCE TO RELATED APPLICATIONS

This application claims the benefit of and priority to U.S. Provisional Application No. 63/331,654, filed Apr. 15, 2022, the entire disclosure of which is incorporated by reference herein.

### BACKGROUND

This present disclosure relates generally to fire suppression systems. More specifically, the present disclosure relates to fire suppression systems for industrial mobile equipment. Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant agent throughout the area. The fire suppressant agent then suppresses or prevents the growth of the fire.

### SUMMARY

At least one embodiment relates to a fire suppression system for a vehicle containing a fire detection device, a tank, a nozzle, and an activator. The fire detection device is configured to detect a fire in a hazard area. The tank is configured to contain a volume of liquid fire suppressant. The nozzle has an outlet at least selectively fluidly coupled to the tank and configured to release a spray of the liquid fire suppressant therefrom in the hazard area. The activator is configured to selectively release the liquid fire suppressant from the tank during a single-agent phase such that at least a portion of the liquid fire suppressant passes through the outlet of the nozzle in response to the fire detection device detecting a fire in the hazard area.

Another embodiment relates to a method for suppressing a fire and cooling a superheated surface of a vehicle. The method includes providing the vehicle with a fire suppression system including a fire detection device, a tank, a nozzle, and an activator. The fire detection device is configured to detect a fire in a hazard area. The tank is configured to contain a volume of liquid fire suppressant. The nozzle has an outlet at least selectively fluidly coupled to the tank and configured to release a spray of the liquid fire suppressant therefrom in the hazard area. The activator is configured to selectively release the liquid fire suppressant from the tank during a single-agent phase such that at least a portion of the liquid fire suppressant passes through the outlet of the nozzle in response to the fire detection device detecting a fire in the hazard area. The method further includes detecting, using the fire detection device, a fire in the vehicle and suppressing the fire using only the liquid fire suppressant during a single-agent phase.

This summary is illustrative only and is not intended to be in any way limiting Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle including a liquid fire suppression system, according to an exemplary embodiment.

FIG. 2 is a schematic diagram of the liquid fire suppression system, according to some embodiments.

FIG. 3 is a perspective view of a spray of a nozzle of the fire suppression system of FIG. 1, according to an exemplary embodiment.

FIG. 4 is a side view of the spray of FIG. 3.

FIG. 5 is a top view of the spray of FIG. 3.

FIG. 6 is a flow chart of an exemplary method of using a liquid fire suppression system, according to an exemplary embodiment.

### DETAILED DESCRIPTION

Before turning to the FIGURES, which illustrate the exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

As used herein, the term “hazard” means any component or surface that has a potential to act as fuel, flammable material, or an ignition source and thereby ignite, produce, sustain, or otherwise cause a flame to be emitted therefrom. A hazard can be a component or surface that routinely becomes heated and has the potential to come into contact with a combustible material. By way of example, the hazard can be an engine component that is routinely heated (e.g., an engine block, a turbocharger, a supercharger, an exhaust component, a pump, a filter, etc.) and that may be positioned adjacent a hose, pipe, or other type of conduit that has the potential to leak a combustible fluid (e.g., fuel, hydraulic oil, engine oil, etc.). By way of another example, the hazard can be an engine component that is routinely heated and that may be positioned such that flammable material from outside of the vehicle (e.g., grass clippings, wood chips, coal dust, refuse, etc.) can accumulate atop or otherwise in contact with the engine component. The terms “dual agent fire suppression system” and “twin-agent fire suppression system” are used herein interchangeable to denote fire suppression systems which use a dry agent and a liquid agent to suppress a fire.

As used herein, the term “non-fluorinated” means the firefighting agent, fire suppressant, or fire suppressant agent is produced without the use of per-and polyfluoroalkyl substance (PFSA) chemistry, and no PFSAs were intentionally added to the suppressants/agents during production. Trace amounts of PFSAs may however be present from incidental exposure during the production, transportation, storage, and/or use of the suppressants/agents.

### Overview

Modern mobile equipment (i.e., industrial vehicles) such as large non-road type construction and mining vehicles are growing larger and larger and require ever increasing amounts of power to operate. To generate this power most mid-to-large class non-road mobile equipment commonly use turbo-charged diesel engines to power the machine and/or generate needed electrical power. However, in generating this power the mobile equipment releases substantial amounts of excess heat, resulting in superheated surfaces (e.g., turbochargers, exhaust manifolds, transmissions, engine blocks, brake systems, etc.) which can serve as ignition and/or re-ignition points for fires. In some cases the superheated surfaces can reach in excess of 2000° F., well above the 850° F. required to ignite fuels like hydraulic oil and diesel oil. These types of vehicle fires are especially hazardous in larger mobile equipment which may have as many as 12 or more turbochargers and which carry substantial amounts of flammable materials (e.g., lubricating oils, gasoline, diesel oil, greases, hydraulic fluids, etc.). Fire suppression systems can be installed onboard mobile equipment and configured to suppress such fires. Some fire suppression systems are dry chemical single-agent systems. However as the mobile equipment developed and more excess heat was generated, even if the dry chemical was able to initially suppress the fire, due to uncooled superheated surfaces within the vehicle the fires may re-ignite. Re-ignition can occur when the flammable materials come into contact with superheated surfaces above an ignition temperature of the flammable materials after the initial fire is suppressed. As such, some fire suppression systems installed in large mobile equipment are twin-agent fire suppression systems, with a dry agent knocking down the fire's flames and a wet agent designed to cool the superheated surfaces and reduce re-ignition potential.

Generally, in a twin-agent fire suppression system, the dry and wet agents are contained in largely independent systems of storage tanks, fluid conduits, and nozzles. A single fire detection circuit may connect the systems. When a fire is detected in a hazard area, the fire detection circuit actuates the fire suppression system. Expellant gas fluidizes the dry agent which is discharged through nozzles into the protected hazard area to suppress the fire. Simultaneously, the wet agent is also discharged in the hazard area. The primary purpose of the dry agent is to knock down the flames of the fire, while the primary purpose of the wet agent is to cool the surrounding areas (e.g., superheated surfaces) and blanket the flammable material. The wet agent can flow into hard to reach areas where flammable liquids may have settled. For large vehicles with multiple superheated surfaces and substantial amounts of flammable material onboard, it is commonly believed that this combination of dry and wet agents is necessary if a fire is to be safely and reliably extinguished.

In certain industries heavily reliant on large mobile equipment regulations may even require the use of twin-agent fire suppression systems in certain vehicles over single-agent alternatives due to the belief that only dual-agent fire suppression systems can safely suppress the fire and cool the superheated surfaces. For example, the National Fire Protection Association (NFPA) 120 “Standards for Fire Prevention and Control in Coal Mines” (2020) requires hydraulic and diesel excavators with hydraulic systems above 567.8 L (150 gal) in the lines to use a dual agent system. (NFPA 120, 5.3.6.1.1). Similarly, NFPA 122 “Standards for Fire Prevention and Control in Metal/Nonmetal Mining and Metal Mineral Processing Facilities” (2020) requires dual agent systems for large vehicles (e.g., vehicle weight at or above 200,000 lb.) which have diesel-powered generators with hydraulic systems containing more than 567.8 L (150 gal) in the lines. (NFPA 122, 12.3.6.1.1). The disclosures of NFPA 120 (2020) and NFPA 122 (2020) are hereby incorporated by reference in their entirety.

The present disclosure relates to a fire suppression system for large mobile equipment (i.e., with hydraulic systems as described herein) that utilizes a single liquid agent to both knock down and suppress the fire's flames and cool the superheated surfaces. As discussed above, other fire suppression systems for large vehicles (e.g., with a hydraulic system with 150 gal in the lines) use a dry agent and a wet agent under the belief both are required to safely suppress fires in these vehicles. The liquid fire suppression system of the present disclosure uses a single liquid agent (i.e., wet chemical agent) which can flow into areas (including areas outside of the protected hazard area) where flammable liquids settle, providing both fire suppression and superior cooling of superheated surfaces while blanketing the flammable liquid and cutting off oxygen to prevent re-ignition. Accordingly, the fire suppression system operates without the need for an additional dry agent (and dedicated dry agent system) to suppress the flames of the fire as required in other twin-agent systems. Because the liquid fire suppression system does not use a dry agent, the system also avoids common issues associated with expelling a dry, powderized agent with a small particle size. When sprayed the dry agent is prone to becoming airborne, and may contaminate equipment and areas that the dry agent was not intended to come in contact with. For example, in the engine compartment of a large vehicle, the engine intakes may allow dry agent to be carried into the engine which can cause substantial damage wholly apart from the damage caused by the fire. The single-agent liquid fire suppression system operates with only the liquid fire suppression agent, reducing material costs and capital investment associated with the additional dry agent components and potentially eliminating the risks posed by airborne dry agent. The single-agent system may also be more environmentally friendly than conventional twin-agent systems, and be used in a broader range of applications such as agriculture, airports, forestry, sea-side operations, waste, and underground equipment operations.

### Vehicle

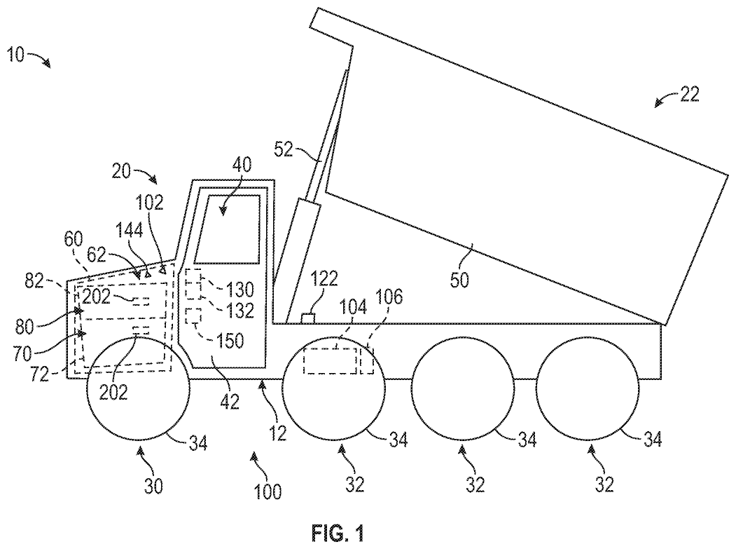

Referring to FIG. 1, mobile equipment is shown according to an exemplary embodiment. The mobile equipment is shown as a vehicle 10. The vehicle 10 may be any type of vehicle, such as a commercial vehicle, a farm vehicle, an industrial vehicle, or a consumer vehicle. Such vehicles can include, but are not limited to: draglines, slag pot carriers, slab carriers, tunnel boring machines, waste management equipment, forestry vehicles, hydraulic excavators, haul trucks, wheeled loaders, dozers, scoop trams, shuttle cars, public transportation vehicles, over-the-road trucks, cargo transport vehicles, graders, dump trucks, and consumer passenger vehicles.

In the embodiment shown in FIG. 1, the vehicle 10 is a dump truck. The vehicle 10 includes a chassis, shown as frame 12, extending longitudinally along the vehicle 10. The frame 12 supports a first portion of the vehicle 10, shown as body 20. In some embodiments, the frame 12 additionally supports a second portion of the vehicle 10, shown as equipment 22. In other embodiments, the equipment 22 is omitted. As shown in FIG. 1, the body 20 is positioned near the front of the frame 12 with respect to the direction of travel of the vehicle 10, and the equipment 22 is positioned rearward of the body 20. In other embodiments, the body 20 extends rearward of the equipment 22.

The vehicle 10 further includes a series of tractive assemblies, shown as front tractive assembly 30 and rear tractive assemblies 32. As shown, the vehicle 10 includes one front tractive assembly 30 and three rear tractive assemblies 32. In other embodiments, the vehicle 10 includes more or fewer front tractive assemblies 30 and/or rear tractive assemblies 32. The front tractive assembly 30 and the rear tractive assemblies 32 each include two or more tractive elements (e.g., wheels, tracks, etc.), shown as wheel and tire assemblies 34. The wheel and tire assemblies 34 are rotatably coupled to the frame 12 and engage the ground. The wheel and tire assemblies 34 support the frame 12, the body 20, and the equipment 22. The front tractive assembly 30 and the rear tractive assemblies 32 can include differentials, drive shafts, bearings, wheel hubs, brakes, and other components.

The body 20 includes a cabin, shown as front cabin 40. The front cabin 40 is configured to house one or more operators throughout operation of the vehicle 10. The front cabin 40 can include components that facilitate operation of the vehicle 10, such as seats, controls for driving the vehicle 10 (e.g., displays, gauges, a steering wheel, pedals, shift levers, etc.), and/or controls for operating the equipment 22 (e.g., touchscreens, switches, knobs, buttons, joysticks, etc.). The body 20 can include one or more doors 42 that open and close to selectively facilitate or prevent access to the front cabin 40. Alternatively, the vehicle 10 may be an autonomous or semiautonomous vehicle. Accordingly, certain processes, such as steering, braking, and accelerating the vehicle 10 and controlling the equipment 22 may be controlled by a controller onboard or offboard the vehicle. The controller may perform such operations without, or with reduced input from, an operator. In such embodiments, certain components may be removed from the front cabin 40 or the front cabin 40 may be omitted entirely.

The components included in the equipment 22 vary based upon the intended use of the vehicle 10. In the embodiment shown in FIG. 1, the vehicle 10 is a dump truck configured to haul and deposit material (e.g., ore, dirt, gravel, sand, coal, etc.). The equipment 22 includes a container, shown as bed 50, that is configured to contain a volume of material. The bed 50 can have an opening along a top side to facilitate depositing material into the bed 50 and an opening along a rear side to facilitate dumping material. The bed 50 is pivotally coupled to the frame 12. The equipment 22 further includes a linear actuator, shown as hydraulic cylinder 52, that is coupled to the frame 12 and the bed 50. The hydraulic cylinder 52 is configured to extend and retract to rotate the bed 50 relative to the frame 12 between a raised position and a lowered position. In the lowered position, the bed 50 is configured to store material for transport. In the raised position, shown in FIG. 1, the bed 50 is configured to dump the material out through the opening along the rear side of the bed 50. In some embodiments, the hydraulic cylinder is a part of a hydraulic system with at least 567.8 L (150 gal) of hydraulic fluid in the lines.

The body 20 further defines an enclosure, shown as engine compartment 60, defining a volume 62 that is at least partially enclosed by the engine compartment 60. As shown, the engine compartment 60 is positioned forward of the front cabin 40 and the equipment 22. In other embodiments, the engine compartment 60 is positioned rearward of the front cabin 40 and/or the equipment 22. Still in other embodiments, the engine compartment 60 is positioned additionally and/or alternatively below the front cabin 40. The engine compartment 60 can include one or more structural members (e.g., frame rails, support members, brackets, etc.), coverings (e.g., sheet metal that extends between structural members, firewalls, body panels, grills, etc.), movable members (e.g., doors, hoods, etc.), or other components coupled to the frame 12, all of which cooperate to define the volume 62. The volume 62 can be accessible, selectively accessible, or inaccessible by an operator positioned outside of the vehicle 10. By way of example, a door may be movable to selectively permit access to the volume 62. In other embodiments, enclosed or partially enclosed volumes are defined by an enclosure of the vehicle 10 other than the engine compartment 60. By way of example, such enclosures can include lubrication rooms, storage areas, and the front cabin 40.

According to an exemplary embodiment, the vehicle 10 includes a first drive system, shown as powertrain 70. The powertrain 70 may include a primary driver, shown as engine 72. The engine 72 receives fuel (e.g., diesel, gasoline, etc.) from a fuel tank and combusts the fuel to generate mechanical energy. In other embodiments, the primary driver is an electric motor that consumes electrical energy (e.g., stored in a battery, from a generator, etc.) to generate mechanical energy. The powertrain 70 further includes a transmission that receives the mechanical energy and provides a rotational mechanical energy output (e.g., at a different speed, torque, and/or direction of rotation than that of the engine 72). The transmission can be rotationally coupled to a transfer case assembly and one or more drive shafts. The one or more drive shafts can be coupled to one or more differentials configured to transfer the rotational mechanical energy from the one or more drive shafts to the front tractive assembly 30 and/or the rear tractive assemblies 32. The front tractive assembly 30 and/or the rear tractive assemblies 32 then propel the vehicle 10. According to an exemplary embodiment, the engine 72 is an internal combustion engine that utilizes compression-ignition of diesel fuel. In alternative embodiments, the engine 72 is another type of device (e.g., a fuel cell, an electric motor, a spark-ignition engine, etc.) that utilizes a different power source (e.g., compressed natural gas, gasoline, hydrogen, electricity, etc.). The powertrain 70 of the vehicle 10 can be a hybrid powertrain or a non-hybrid powertrain (e.g., a fully electric powertrain, a powertrain powered exclusively by an internal combustion engine, etc.). The powertrain 70 of the vehicle 10 can further include one or more turbochargers.

In some embodiments, the vehicle 10 includes a second drive system, shown as equipment drive system 80 (e.g., hydraulic system). The equipment drive system 80 is configured to power actuation of the equipment 22. The equipment drive system 80 includes a driver, shown as pump 82. The pump 82 is a hydraulic pump configured to supply pressurized hydraulic fluid to and/or remove pressurized hydraulic fluid from the hydraulic cylinder 52 to raise and lower the bed 50. The pump 82 can be directly powered by the engine 72, can be powered by another energy source (e.g., a second engine, an electric motor powered by energy stored in a battery, etc.). In other embodiments, the equipment drive system 80 is configured to provide a different type of energy to power actuation of the equipment 22 (e.g., pressurized gas, electrical energy, a rotating shaft, etc.). Accordingly, in such embodiments, the driver of the equipment drive system 80 may instead be a compressor, a generator, an electric motor, or another type of driver. Alternatively, the pump 82 can be omitted, and the equipment drive system 80 may be driven directly by the engine 72 (e.g., a through a drive shaft). In some embodiments, the equipment drive system 80 is a hydraulic system with at least 567.8 L (150 gal) of pressurized hydraulic fluid (e.g., hydraulic oil) in the lines.

The powertrain 70 and/or the equipment drive system 80 extend at least partially within the volume 62 defined by the engine compartment 60. As shown in FIG. 1, the engine 72 and the pump 82 are positioned within the engine compartment 60. Other components of the powertrain 70 (e.g., the transmission, driveshafts, etc.) extend outside of the engine compartment 60. Other components of the equipment drive system 80 (e.g., hydraulic lines, valves, etc.) extend outside of the engine compartment 60. In other embodiments, the equipment drive system 80 is positioned completely within or completely outside of the engine compartment 60.

Throughout operation, one or more components or surfaces of the powertrain 70 and/or the equipment drive system 80 have the potential to supply flammable material or act as an ignition source, such that a flame is emitted therefrom. Such flames can occur as a result of malfunctioning components, buildup of outside sources of flammable material, or through other circumstances. By way of example, a fuel line or a hydraulic fluid line can rupture, spraying fuel or hydraulic fluid that acts as a flammable material to fuel a fire. By way of another example, flammable material from outside of the vehicle 10 (e.g., sawdust, grass clippings, coal dust, etc.) can build up and fuel a fire. Throughout operation, many components of the powertrain 70 and the equipment drive system 80 regularly reach elevated temperatures. Components within the vehicle 10 can reach elevated temperatures due to the combustion of fuel (e.g., contact with the combusting fuel, contact with exhaust gasses, etc.), due to electrical resistance, due to resistance within a hydraulic or pneumatic circuit, due to friction, or through other sources. In some embodiments the components may even become superheated. As used herein, the term “superheated” means at or above 850° F. When flammable materials come into contact with such superheated components and surfaces, the flammable materials can ignite, causing flames to be emitted.

Any component or surface that has a potential to act as fuel, flammable material, or an ignition source and thereby ignite, produce, sustain, or otherwise cause an undesired flame to be emitted therefrom is referred to herein as a “hazard.” Potential hazards within the vehicle 10 include, but are not limited to, heated surfaces of a block of the engine 72, motors, turbochargers, superchargers, filters, exhaust components, radiators, pumps, compressors, valves, wires, fluid lines, and filters.

### Liquid Fire Suppression System

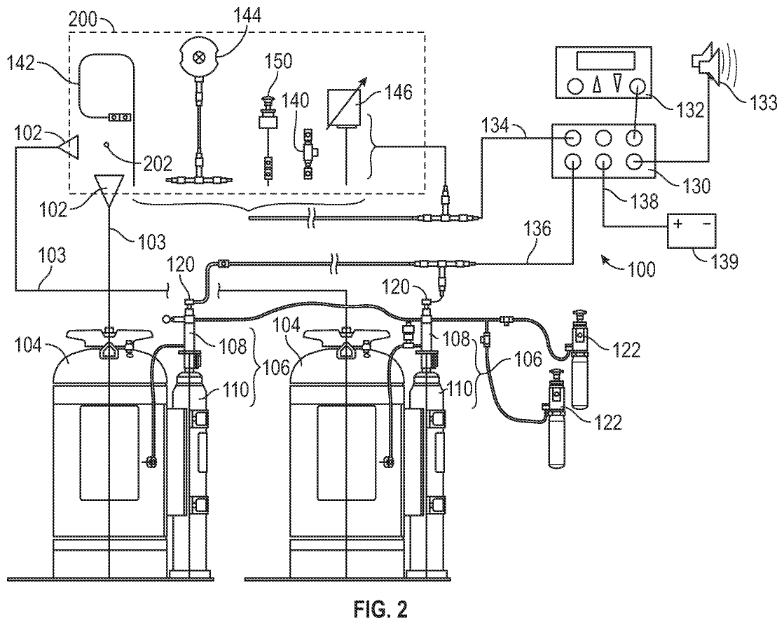

Referring to FIG. 2, the vehicle 10 further includes a liquid fire suppression system 100. The liquid fire suppression system 100 is configured to dispense or distribute a liquid fire suppressant agent onto and/or nearby a fire in a protected hazard area, extinguishing the fire and cooling superheated surfaces in protected hazard area to prevent the fire from spreading or re-igniting. The liquid fire suppression system 100 supplies liquid fire suppressant agent to one or more nozzles 102 through fluid conduits (e.g., pipes, hoses, etc.), shown as hoses 103, to protect a hazard area 200 containing one or more hazards 202.

As shown in FIG. 2, the liquid fire suppression system 100 includes one or more vessels, cylinders, or storage tanks 104 containing a liquid fire suppressant agent. A pressurized cylinder assembly 106 (e.g., vessel, container, vat, drum, tank, canister, pressure vessel, can, cartridge, etc.) is configured to store pressurized expellant gas for pressurizing a corresponding one of the storage tanks 104 for delivery of the liquid agent under an operating pressure to the nozzles 102 to address a fire in the hazard 202. As shown, the pressurized cylinder assemblies 106 are positioned outside of the storage tanks 104. In other embodiments, pressurized expellant gas is stored within the storage tanks 104. In one embodiment, each pressurized cylinder assembly 106 includes an activator, shown as rupturing device 108, which punctures a rupture disc of a pressurized cylinder 110 containing a pressurized expellant gas, such as for example nitrogen, to pressurize the corresponding storage tank 104 for delivery of the liquid fire suppressant agent under pressure. The expellant gas may be an inert gas. In some embodiments, the expellant gas is air, carbon dioxide, or nitrogen.

In order to operate the rupturing device 108, the system 100 provides for automatic actuation and manual operation of the rupturing device 108 to provide for respective automated and manual delivery of the liquid chemical agent in response to detection of a fire for protection of the hazard 202. In one embodiment, the rupturing device 108 includes a puncturing pin or member that is driven into the rupture disc of the pressurized cylinder 110 for release of the pressurized expellant gas. The puncturing pin of the rupturing device 108 may be driven electrically or pneumatically to puncture the rupture disc of the pressurized cylinder 110. In another embodiment, the activator is instead a valve or another type of device that selectively fluidly couples the storage tank 104 and the pressurized cylinder 110.

In one embodiment, the rupturing device 108 includes a protracted actuation device (PAD) 120 for driving the puncturing pin of the rupturing device 108 into the rupture disc. The PAD 120 generally includes an electrically coupled rod or member that is disposed above the puncturing pin. When an electrical signal is delivered to the PAD 120, the rod of the PAD is driven directly or indirectly into the puncturing pin which punctures the rupture disc of the pressurized cylinder 110. The system 100 can provide for automatic and/or manual operation of the PAD 120. The system 100 can further provide for one or more remote manual operating stations 122 to manually actuate the system 100. The manual operating stations 122 can rupture a canister of pressurized gas, for example, nitrogen at 1800 psi, to fill and pressurize an actuation line which in turn drives the puncturing pin of the rupturing device 108 into the rupturing disc thereby actuating the system 100.

In an alternative embodiment, the pressurized cylinder assembly 106 is omitted, and the liquid fire suppressant agent is otherwise expelled from the storage tank 104. By way of example, the storage tank 104 may also be filled with a pressurized expellant gas, and the expellant gas may force the liquid fire suppressant agent out of the storage tank 104 and through the hose 103. In such an embodiment, the system 100 may utilize a different type of activator instead of the rupturing device 108. By way of example, the system 100 may include a valve positioned downstream of the storage tank 104 (e.g., along one of the hoses 103, etc.) that selectively prevents flow of fire suppressant agent through the hoses 103 and out of the nozzles 102. In some embodiments, the liquid fire suppressant agent is entirely contained in the storage tank 104 until released in response to a hazard.

Referring again to FIG. 2, the system 100 includes a controller for automated and/or manual operation and monitoring of the system 100. In one embodiment, the system 100 includes a centralized controller or interface control module (ICM) 130. The system 100 can include a display device 132 coupled to the ICM 130 which displays information to a user and provides for user input to the ICM 130. In some embodiments, a user can provide a user input to the display device 132 to manually activate the liquid fire suppression system 100. An audio alarm or speaker 133 can also be coupled to the ICM 130 to provide for an audio alert regarding the status of the system 100.

ICM 130 is configured to monitor one or more conditions and determine if those conditions are indicative of a nearby fire. Upon detecting a nearby fire, ICM 130 activates rupturing device 108, causing the liquid fire suppressant agent to leave nozzles 102 and extinguish the fire. To provide for fire detection and actuation of the pressurized cylinder assemblies 106 and the liquid fire suppression system 100, the ICM 130 can further include an input data bus 134 coupled to one or more detection sensors, an output data bus 136 coupled to the PADs 120, and an input power supply bus 138 coupled to a power source, shown as battery 139, for powering the ICM 130 and the control and actuating signals. The input bus 134 provides for interconnection of digital and analog devices to the ICM 130. The input bus 134 can include one or more fire detection devices (e.g., sensors) and/or manual actuating devices 150. The fire detection devices of the system 100 can include analog and digital devices for various modes for fire detection including: (i) spot thermal detectors 140 to determine when the surrounding air exceeds a set temperature, (ii) linear detection wire 142 which conveys a detection signal from two wires that are brought into contact upon a separating insulation material melting in the presence of a fire, (iii) optical sensors 144 which differentiate between open flames and hydrocarbon signatures, and (iv) a linear pressure detector 146 in which pressure of an air line increases in the presence of sufficient heat. A manual actuating device 150 is shown as a manual push button which sends an actuating signal to the ICM 130 for output of an electrical actuating signal along to the PAD 120 of one or more of the pressurized cylinder assemblies 106. Accordingly, the system 100 provides for manual actuation of the system 100 by transmission of an electrical signal to the PAD 120. Together the fire detection devices and manual actuating devices 150 define a detecting circuit of the system 100 for automatic and/or manual detection of a fire event.

In some embodiments, the liquid fire suppression system 100 includes mechanical fire detection devices. By way of example, the liquid fire suppression system 100 can include a fusible link coupled to a cable or other type of tensile member that is held in tension. When the fusible link is exposed to a fire, solder within the fusible link melts, releasing tension on the cable. This change in tension can act as an input to the ICM 130 (e.g., through a strain gage or load cell). Alternatively, the cable can be coupled to the rupturing device 108, and the rupturing device 108 can be configured to pierce the rupture disc in response to a release of the tension on the cable.

Referring again to FIG. 2, the ICM 130 can be a programmable controller having a processor and a memory device. The ICM 130 can receive input signals on the input bus 134 from the fire detection devices for processing and where appropriate, generating an actuating signal to each PAD 120 along the output bus 136. In operation, upon detection of a fire event (e.g., automatically or manually), the ICM 130 activates each PAD 120, causing the rupturing device 108 to fluidly couple the pressurized cylinder 110 and the storage tank 104. In embodiments where the pressurized cylinder assembly 106 is omitted, the ICM 130 may instead interact with (e.g., activate) a different type of activator. Alternatively, the rupturing devices 108 can be activated mechanically using the manual operating stations 122. The expellant gas forces the fire suppressant agent out through the hoses 103 and the nozzles 102, suppressing any fires near the hazards 202. The liquid fire suppressant agent is expelled until one or both of the storage tank 104 and the pressurized cylinder 110 are depleted.

The storage tank 104 and/or the pressurized cylinder 110 can be sized to correspond to the number of nozzles 102 present in the system 100 such that a desired volume of liquid fire suppressant agent is expelled through each nozzle 102. In some embodiments, the storage tank 104 has a capacity of 3, 5, 10, 15, 30, 45, 50, or 75 gallons. These capacities can correspond with the use of between 6 and 24 nozzles 102. The average time required to completely discharge the storage tank 104 can range from between 20 and 60 seconds.

In some embodiments, the ICM 130 is configured to extinguish the fire with only the liquid fire suppressant agent. During testing of the liquid fire suppression system using only a liquid fire suppression agent, the liquid fire suppression system was discovered to have an unexpected benefit over twin-agent fire suppression systems. In testing, the liquid fire suppression system was compared to a conventional twin-agent fire suppression system typically used in large mobile equipment. The test involved suppressing a fire on a hazard including a superheated surface in a pool of flammable liquid, at or near a temperature of 2500° F. Contrary to expectations, the liquid fire suppression system using only the liquid fire suppressant agent was found to be more effective at suppressing the fire than a twin-agent fire suppression system using the same liquid fire suppressant agent in combination with a dry agent. In other words, the liquid fire suppressant agent was discovered to be more effective suppressing a fire on its own than when combined with a dry agent as is typical. Specifically, the liquid fire suppression system was successfully able to knock down the flames of the fire within 5 seconds, while cooling the superheated surface below 850° F. within 10 seconds. Successfully suppressing the fire and cooling the superheated surfaces with a liquid single agent is advantageous, as this obviates the need for dry agent-specific tanks, fluid conduits, and nozzles, and reduces the chances of contamination and unintended damage attributable to the dry fire suppressant agent.

In some embodiments on mobile equipment with over 567.8 L (150 gal) of pressurized hydraulic fluid in the lines, the ICM 130 of liquid fire suppression system 100 is configured to extinguish the fire with only the liquid fire suppressant agent in a single-agent phase. In the single-agent phase, the liquid fire suppression system 100 suppresses the fire using only the liquid fire suppressant agent, and without the addition of another fire suppressant agent such as a dry powder agent. Before the single-agent phase, the liquid fire suppression system 100 detects a fire using one or more fire detection devices and/or manual actuating devices 150. Upon detection of a fire (e.g., automatically or manually), the ICM 130 activates each PAD 120, causing the rupturing device 108 to fluidly couple the pressurized cylinder 110 and the storage tank 104 and causing the liquid fire suppressant in the now single-agent phase to address the fire without the addition of another fire suppressant agent. Specifically, at the beginning of the single-agent phase, the fire is an untreated fire. As used herein, the term “untreated fire” means a fire that has yet to be addressed by a fire suppression system and/or has not come into contact with a fire suppressant agent. During the single-agent phase, the liquid fire suppression system 100 cause only the liquid fire suppressant agent to be expelled into the protected hazard area. Therefore, in some embodiments, during the single-agent phase the untreated fire only comes into contact with the liquid fire suppressant agent. The liquid fire suppressant agent knocks down the flames of the fire and cools any superheated surfaces in the protected hazard area to below a critical temperature. In some embodiments, the critical temperature is the temperature at which one or more flammable materials in the protected hazard area may ignite and/or re-ignite at. For example, the critical temperature may be 850° F. (454° C.). As another example, the critical temperature is 470° F. (approximately 243° C.) for Class A fires. The liquid fire suppression system 100 can be designed to cause a sufficient quantity of liquid fire suppressant for a sufficient length of time to be expelled through the nozzles 102 such that after a complete discharge of the storage tank 104 and/or the pressurized cylinder 110 the superheated surfaces in the protected hazard area are below the critical temperature. For example, in a large vehicle with superheated surfaces predicted to be 1200° F., the liquid fire suppression system 100 can be designed to cause enough liquid suppressant agent to bring the temperature of the superheated surfaces from 1200° F. to 850° F. In some embodiments, the fire suppression system 100 can be designed to bring the temperature of the superheated surfaces below 470° F. In some embodiments, the fire suppression system 100 is designed to bring the temperature of the superheated surfaces below the critical temperature (i.e., ignition temperature) of any flammable materials in the hazard area.

In some embodiments, at the end and/or directly after the single-agent phase, the fire is suppressed and the superheated surface(s) in the protected hazard area are below the critical temperature. No other fire suppressant agent is needed to suppress the fire.

Referring back to FIG. 1, the liquid fire suppression system 100 is included onboard the vehicle 10. Accordingly, the liquid fire suppression system 100 stays with the vehicle 10 to protect the vehicle 10 during periods of operation and/or periods of inactivity (e.g., storage, transport, etc.). As described above, in some embodiments the vehicle 10 is a vehicle subject to NFPA 120 and/or NFPA 122 and includes an equipment drive system 80 (i.e., hydraulic system) which has more than 567.8 L (150 gal) of pressurized hydraulic fluid in the lines. As shown, the nozzle 102 is positioned within a protected hazard area, shown as engine compartment 60, to protect hazards included in the powertrain 70 and the equipment drive system 80. An optical sensor 144 is positioned within the engine compartment 60 to detect fires within the engine compartment 60. Other detection devices (e.g., the spot thermal detectors 140, the linear detection wires 142, the linear pressure detector 146, etc.) can additionally or alternatively be used. Nozzles 102 and sensors can additionally be included in other areas of the vehicle 10 to protect hazards located elsewhere within the vehicle 10. The storage tanks 104 and the pressurized cylinder assembly 106 are coupled to the frame 12 and positioned outside of the engine compartment 60. The ICM 130 and the display device 132 are positioned within the front cabin 40 to facilitate access by an operator of the vehicle 10. A manual actuating device 150 is positioned within the front cabin 40, and a manual operating station 122 is coupled to the frame 12 outside the front cabin 40 to facilitate manual activation of the liquid fire suppression system 100 from anywhere on the vehicle 10. It should be understood that the locations of these components shown in FIG. 1 are exemplary only, and the liquid fire suppression system 100 can be otherwise positioned within the vehicle 10 in other embodiments.

Additionally or alternatively, the vehicle 10 can include nozzles 102 positioned to protect hazards 202 positioned outside of the engine compartment 60. Such nozzles 102 and hazards 202 can be positioned within enclosures of the vehicle 10 other than the engine compartment 60 (e.g., lubrication rooms, enclosures that contain components of the equipment drive system 80 but do not contain the engine 72, etc.). Alternatively, the nozzles 102 and the hazards 202 can be positioned outside of enclosures and exposed to the surrounding environment. Examples of hazards 202 that can be positioned outside of the engine compartment 60 and/or other enclosures include brakes, hydraulic pumps, filters, batteries, tires, mobile generators, and conveyors.

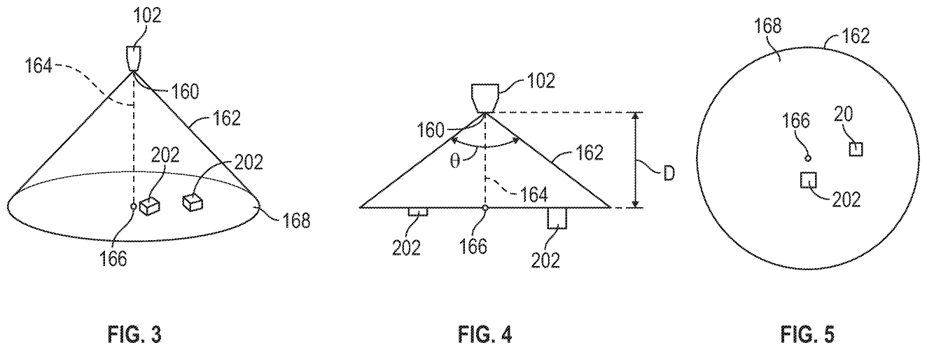

Referring to FIGS. 3-5, each nozzle 102 has an outlet 160, from which a spray 162 of fire suppressant agent is released during activation of the liquid fire suppression system 100. The outlet 160 is fluidly coupled to the hoses 103 such that fire suppressant agent can be supplied to the outlet 160 from the storage tanks 104. The spray 162 extends along an axis 164 toward a point 166. The axis 164 is oriented generally toward one or more hazards 202, such that the spray 162 suppresses any fires and prevents subsequent ignitions caused by the hazards 202. The spray 162 directly blankets or covers an area, shown as blanketed area 168, with fire suppressant agent. The blanketed area 168 is defined perpendicular to the axis 164. In one embodiment, the blanketed area 168 is circular. The spray 162 further has a coverage area or effective suppression area at the hazard 202. The spray 162 is effective at suppressing fires located within the effective suppression area. Accordingly, if a hazard 202 is located within the effective suppression area, the hazard 202 is protected by the spray 162. The effective suppression area may be larger than and extend outside of the blanketed area 168. As such, a hazard 202 located outside of the blanketed area 168 can still be protected by the spray 162. The effective suppression area may be circular, similar to the blanketed area 168. Alternatively, the effective suppression may have another shape (e.g., organically shaped, square, triangular, etc.).

The blanketed area 168 of the spray 162 increases in size as the spray 162 extends along the axis 164 away from the outlet 160. The nozzle 102 is placed such that the outlet 160 is a distance D away from the nearest hazard 202. The distance D is measured along the axis 164. The nozzle 102 can be placed such that distance D is greater than 48 inches. In some embodiments, the distance D is greater than 54 inches. In some embodiments, the distance D is at least 60 inches. The size of the effective suppression area may be selected based upon the type of area that is desired to be covered. Having the ability to select different effective suppression areas may facilitate covering different sized hazards with minimal overspray beyond the desired coverage area.

In some embodiments, the liquid fire suppression system 100 using the liquid fire suppressant agent described above may be a twin-agent system. The liquid fire suppression system 100 when used as a twin-agent system may include additional pressurized cylinders 110, storage tanks 104, fluid conduits 103, and nozzles 102 for use with the dry agent in addition to the pressurized cylinder 110, storage tanks 104, fluid conduits 103, and nozzles 102 for use with the liquid fire suppressant agent. The twin-agent system may include a twin-agent phase similar to the single-agent phase as described above, except that the liquid fire suppressant agent is not used to the exclusion of another fire suppression agent, but with and/or in addition to another fire suppression agent such as a dry agent. An exemplary dry agent that may be used in conjunction with the liquid fire suppressant agent disclosed herein may be the FORAY multipurpose dry chemical agent manufactured by ANSUL®, a brand of Tyco Fire Products, LP. In the twin-agent phase, the dry agent and the liquid fire suppressant agent may be simultaneously applied to the fire by liquid fire suppression system 100. In other embodiments of a twin-agent fire suppression system using the liquid fire suppressant agent with a dry agent, the twin-agents may be released in series, with the dry agent being released prior to the release of the liquid fire suppression agent. In some embodiments, the liquid fire suppressant agent is not released until one of the storage tanks 104 containing the dry agent and/or the pressurized cylinder 110 is exhausted. In other embodiments, the liquid fire suppressant agent is released, for example by ICM 130, after the dry agent is released but prior to the exhaustion of the tank 104 and/or pressurized cylinder 110.

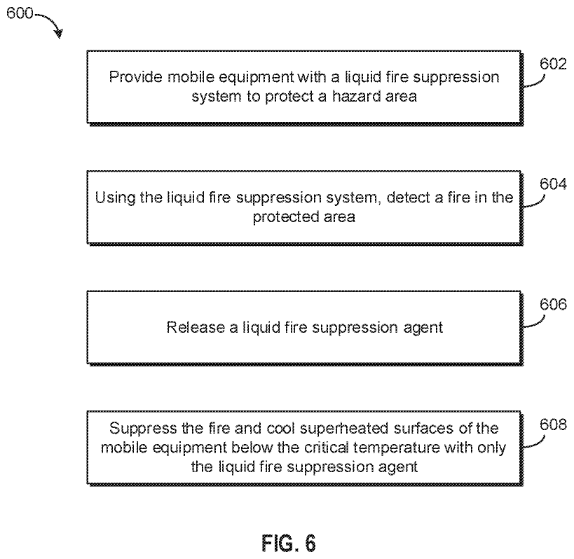

Referring now to FIG. 6, a flow chart illustrating a method 600 for suppressing a fire in mobile equipment using a liquid only fire suppression system is shown, according to some embodiments. In some embodiments, the method 600 is performed by liquid fire suppression system 100 described above with reference to FIGS. 1 and 2. At step 602, mobile equipment is provided with a liquid fire suppression system to protect a hazard area. In some embodiments, the mobile equipment may be any type of vehicle, such as a commercial vehicle, a farm vehicle, an industrial vehicle, or a consumer vehicle. In some embodiments, the mobile equipment is a vehicle with a hydraulic system including more than 567.8 L (150 gal) of pressurized hydraulic fluid in the lines. Additionally, the mobile equipment may be subject to NFPA 120 5.3.6.1.1 or NFPA 122 12.3.6.1.1. The liquid fire suppression system may be configured to detect a fire in a protected hazard area and activate an actuator to release a liquid fire suppressant in protected hazard area of the vehicle (e.g., engine compartment, battery compartment, brake system, etc.).

The protected hazard area may include one or more hazards such as heated surfaces of a block of the engine 72 vehicle 10, motors, turbochargers, superchargers, filters, exhaust components, radiators, pumps, compressors, valves, wires, fluid lines, and filters. In some embodiments, the protected hazard area includes one or more nozzles 102 of a fire suppression system such as liquid fire suppression system 100.

At step 604, using the liquid fire suppression system a fire is detected within the protected hazard area of the mobile equipment. In some embodiments, the fire is detected by one or more fire detection devices (e.g., sensors) and/or manual actuating devices 150 installed in the liquid fire suppression system. A controller, such as ICM 130 may be included in the liquid fire suppression system to receive the signals from the one or more fire detection devices.

At step 606, the liquid fire suppression system releases a liquid fire suppression agent. In some embodiments, the liquid fire suppression system activates one or more rupturing devices to release a pressurized expellant gas, which in turn causes the liquid fire suppressant agent to be expelled from its storage tank, through one or more fluid conduits, and out of one or more nozzles in the protected hazard area.

At step 608, the fire is suppressed, and the superheated surfaces are cooled below a critical temperature with only the liquid fire suppression agent. During step 608, the liquid fire suppressant agent is configured to knock down the fire, cool any superheated surfaces in the protected hazard area, and blanket the flammable material in the protected hazard area to reduce the risk of re-ignition. The liquid fire suppressant agent is configured to do all of the above without the need for an additional fire suppressant agent such as a dry chemical powder agent. The critical temperature is the temperature at which the flammable materials may reignite. In some embodiments, the fire is suppressed within 5 seconds of step 606. In some embodiments, the superheated surfaces are cooled below the critical temperature within 10 seconds of step 606. During step 608, no dry agent is required to safely and efficiently suppress the fire, the liquid fire suppressant agent can be configured both knock down the flames and cool the superheated surfaces on its own.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The present disclosure contemplates that even in a single-agent liquid fire suppression system as described herein, in addition to the liquid fire suppressant agent a fire may also be suppressed in some part due to the expellant gas used to expel the liquid fire suppression agent from the storage tanks. It should be understood therefore that the term “single-agent” as used herein refers to a single non-gaseous phase agent system, but is not intended to exclude the additional use of gases which may also be used to address a fire. For example, when expelling the liquid fire suppressant agent using nitrogen gas, the nitrogen gas may displace a portion of the oxygen in the protected hazard area which may in turn contribute to the suppression of the fire. Such effects are understood to be included within a single-agent fire suppression system.

What is claimed is:

1. A fire suppression system for a vehicle, the fire suppression system comprising:
a fire detection device configured to detect a fire in a hazard area;
a tank configured to contain a volume of liquid fire suppressant;
a nozzle having an outlet at least selectively fluidly coupled to the tank and configured to release a spray of the liquid fire suppressant therefrom in the hazard area; and
an activator configured to selectively release the liquid fire suppressant from the tank during a single-agent phase such that at least a portion of the liquid fire suppressant passes through the outlet of the nozzle in response to the fire detection device detecting the fire in the hazard area.

2. The fire suppression system of claim 1, wherein the single-agent phase is a liquid-only single-agent phase.

3. The fire suppression system of claim 1, wherein the activator is configured to only activate during the single-agent phase.

4. The fire suppression system of claim 1, wherein the liquid fire suppressant is configured to knock down the fire and cool a superheated surface in the hazard area below a critical temperature.

5. The fire suppression system of claim 4, wherein the critical temperature is the temperature at which a flammable material present in the hazard area ignites.

6. The fire suppression system of claim 4, wherein the critical temperature is 850 F.

7. The fire suppression system of claim 4, wherein during the single-agent phase the liquid fire suppressant entirely suppresses the fire and cools the superheated surface without the addition of a dry fire suppressant.

8. The fire suppression system of claim 4, wherein when the single-agent phase begins, the fire is untreated, and when the single-agent phase ends, the fire is suppressed and the superheated surface is below the critical temperature.

9. The fire suppression system of claim 1, wherein the vehicle comprises a hydraulic system with at least 150 gallons of hydraulic fluid.

10. A method for suppressing a fire and cooling a superheated surface of a vehicle, comprising:
providing the vehicle with a fire suppression system comprising:
a fire detection device configured to detect a fire in the vehicle;
a tank configured to contain a volume of liquid fire suppressant;
a nozzle having an outlet at least selectively fluidly coupled to the tank and configured to release a spray of the liquid fire suppressant therefrom in the vehicle;
an activator configured to selectively release the liquid fire suppressant from the tank during a single-agent phase such that at least a portion of the liquid fire suppressant passes through the outlet of the nozzle in response to the fire detection device detecting the fire in the vehicle;
detecting, using the fire detection device, the fire in the vehicle; and
suppressing the fire using only the liquid fire suppressant during a single-agent phase.

11. The method of claim 10, wherein prior to contact with the liquid fire suppressant, the fire is untreated.

12. The method of claim 10, wherein suppressing the fire includes knocking down flames of the fire and cooling the superheated surface of the vehicle below a critical temperature.

13. The method of claim 12, where the critical temperature is the temperature at which a flammable material present may ignite.

14. The method of claim 13, wherein the critical temperature is between and 750° F. and 1000° F.

15. The method of claim 14, wherein the critical temperature is between 820° F. and 900° F.

16. The method of claim 15, wherein the critical temperature is 850° F.

17. The method of claim 10, wherein during the single-agent phase the liquid fire suppressant entirely suppresses the fire and cools the superheated surface without the addition of a dry fire suppressant.

18. The method of claim 10, wherein when the single-agent phase begins, the fire is untreated, and when the single-agent phase ends, the fire is suppressed and the superheated surface is below the critical temperature.

19. The method of claim 10, wherein the vehicle further comprises at least one of a hydraulic system with approximately 150 gallons of hydraulic fluid.

20. A vehicle, comprising:
a hydraulic system with at least 150 gallons of hydraulic fluid; and
a fire suppression system comprising:
a fire detection device configured to detect a fire in a hazard area of the vehicle, wherein the hazard area contains at least a portion of the hydraulic system;
a tank configured to contain a volume of fire suppressant;
a nozzle having an outlet at least selectively fluidly coupled to the tank and configured to release a spray of the fire suppressant therefrom in the hazard area;
an activator configured to selectively release the fire suppressant from the tank such that at least a portion of the fire suppressant passes through the outlet of the nozzle in response to the fire detection device detecting a fire in the hazard area,
wherein the fire suppression system is only configured to use fire suppressant that is liquid, and wherein the liquid fire suppressant entirely suppresses a fire and cools the hazard area without the addition of a dry fire suppressant.
